(19) United States
(12) Patent Application Publication
(10) Pub. No.: US 2009/0167198 A1
(43) Pub. Date: Jul. 2, 2009

(54) Light string having shunt circuitry arranged on husk of light bulb assembly

(76) Inventor: Chang Fu Tsai, Taichung (TW)

Correspondence Address: Joe McKinney Muncy, PO Box 1364, Fairfax, VA, 22038-1364, US

(21) Appl. No.: 12/003,830

(22) Filed: Jan. 2, 2008

(51) Int. Cl. H05B 37/00

(52) U.S. Cl. 315/192

(57) ABSTRACT

Provided is a light string with a light bulb having additional shunt circuitry. The light string is comprised by a plurality of light bulb units electrically interconnected by conductive wires. Each light bulb unit includes a socket assembly in which a husk along with a light bulb is electrically assembled, each light bulb arranged with switching diode or resistor so as to configure a shunt circuitry. Accordingly, the current flows through the additional shunt circuitry configured by the switching diode or resistor arranged on the husk when the light bulb is fallen, broken or the tungsten filament and shunt circuitry within the light bulb is broken, such that the remaining light bulbs can still functionally work.

### BACKGROUND OF THE INVENTION

1. Field of the Invention

The present invention relates to a circuitry, and particularly to a shunt circuitry for use with a light bulb of a light string in which each and every light bulb is electrically connected in serial. The shunt circuitry ensures each and every light bulb functionally lights up even when at least one of the light bulb is broken, therefore ensuring the light strings work functionally without being negatively effected.

2. Description of the Prior Art

In general, light bulbs used in light strings is referred to incandescent bulbs and which are interconnected in serial in use. Alternatively, a plurality of light strings are electrically interconnected in parallel in use. However, if one of the light bulbs is broken, or one of the light bulb along with the husk is separated from its socket and creating an open-circuit, the current is then bypassed to a shunting device located within the light bulb such that the rest of the light bulbs can still functionally light up.

Accordingly, the present invention is to provide a solution to the problem encountered by the existing technology and which is really what the customers expect for.

The issue to be addressed is discussed as below. The conventional light string is made from interconnecting a plurality of incandescent bulbs, each configured with a tungsten filament, in serial when in use. Alternatively, a plurality of light strings interconnected in parallel in use. Once the tungsten filament is broken, the current then flows through a shunt circuitry configured within the incandescent bulb such that the rest of the light bulbs can still functionally work. However, once the incandescent bulb and the shunt circuitry are both broken, or the incandescent bulb is separated and fallen therefrom, the an open-circuit will be established, and the whole light string will fail to light up.

### SUMMARY OF THE INVENTION

Feature for resolving the current issue. Provided is a light string with a light bulb having additional shunt circuitry. The light string is comprised by a plurality of light bulb units electrically interconnected by conductive wires. Each light bulb unit includes a socket assembly in which a husk along with a light bulb is electrically assembled, each light bulb arranged with switching diode or resistor so as to configure a shunt circuitry. Accordingly, the current flows through the additional shunt circuitry configured by the switching diode or resistor arranged on the husk when the light bulb is fallen, broken or the tungsten filament and shunt circuitry within the light bulb is broken, such that the remaining light bulbs can still functionally work.

Achievement by the current application as compared to the existing prior arts. Only when one of the tungsten filament and the shunt circuitry is still working, then the rest of the light bulbs may work functionally. On the other hand, the husk along with the light bulb has not fallen from the socket, then the rest of the light string can functionally work. However, the light bulb may easily fall from its socket when external force is applied. In addition, both the tungsten filament and the shunt circuit are easily damaged and/ or broken, then the whole light string is out of function. It is really a waste, and creates an inconvenient situation to the user. To the contrary, even when both the tungsten filament and the shunt circuit are broken, the switching diode and/or resistor provided can still work as a bypass circuit such that the whole light string can functionally work. As a result, even one or two light bulbs are damaged, the rest can still function. Thereby increasing the value of the light string.

Other objects, features and advantages of the invention will be apparent from the following detailed description taken in connection with the accompanying drawings.

### BRIEF DESCRIPTION OF THE DRAWINGS

The present invention will be apparent to those skilled in the art by reading the following description of preferred embodiments thereof, with reference to the attached drawings, wherein:

FIG. 1 is an illustration of a first embodiment of a light string made in accordance with the present invention;

FIG. 2 is a first embodiment of a first circuitry;

FIG. 3 is a second embodiment of the second circuitry;

FIG. 4 is an illustration of another embodiment;

FIG. 5 is still an illustration of another embodiment; and

FIG. 6 is yet still an illustration of another embodiment.

### DETAILED DESCRIPTION OF PREFERRED EMBODIMENT

The present invention provides a shunt circuit configured by either a switching diode or a resistor arranged on the husk. As such, even when an open-circuit is happened to one of the light bulbs, the rest of the light bulbs may still functionally work without being negatively effected.

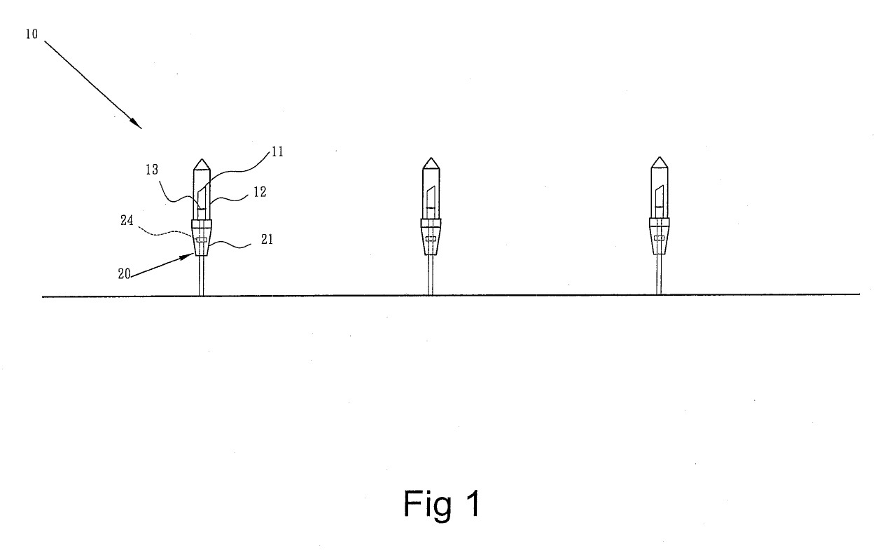

Referring to FIGS. 1 to 3, an illustration of a light bulb made in accordance with the present invention. The light string 10, as shown in FIG. 1, includes a tungsten filament 11, a shunt circuitry 11 and a light bulb 12.

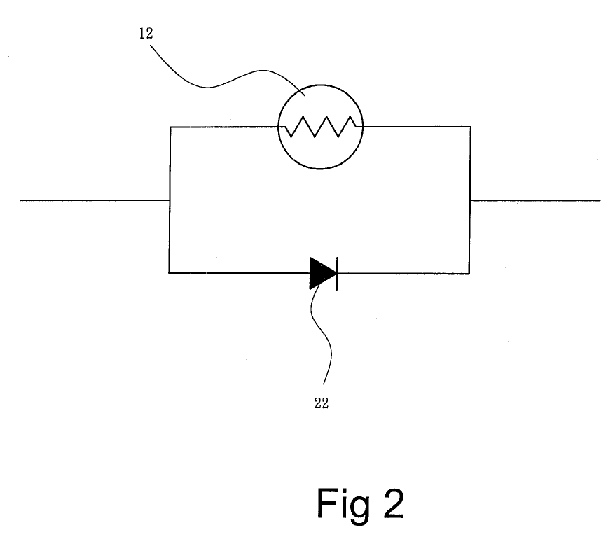

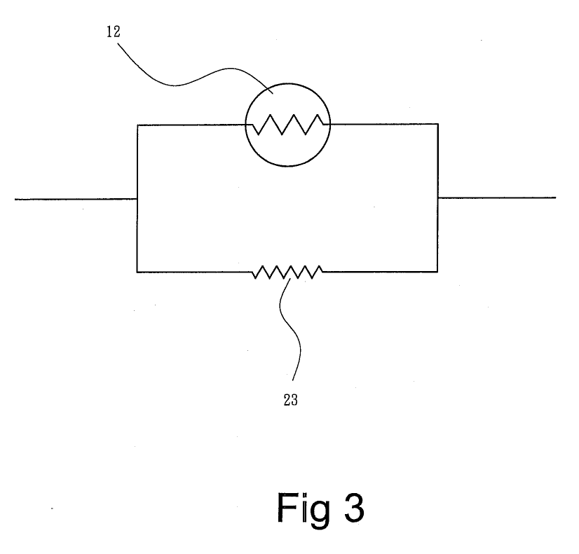

A socket assembly 20 is configured by a bulb holder and a husk 21. The socket assembly 20 is arranged with conductive wires supplying power to the bulb 12. A shunt device or circuit 24 is electrically connected to the wires of the husk 21, and which can be made from a switching diode 22, as shown in FIG. 2. Or alternatively, a resistor 23, as shown in FIG. 3, can be interconnected to the wires of the husk 21 in parallel. The measurement is to integrate the switching diode 22 or the resistor 23 in a plurality of light bulbs interconnected in serial, specially integrated into the husk 21. Accordingly, the shunt device is interconnected in parallel from the viewpoint of circuitry. As a result, even one of the light bulb is broken or in open-circuit, the power can still flow through the switching diode 22 or the resistor 23 such that the rest of the light bulbs 12 may still functionally work. It is apparently to see if the whole light string fails, while it will be difficult to get noticed if only one or two light bulbs failed in a whole light string.

The defective rate of a light string configured by a plurality of light bulbs are different. There is no 100% reliability of the shunt device 13 located within the light bulb 12. As result, once the light bulb 12 is broken or fall apart, the whole light string will fail to light up. However, the shunt device made in accordance with the present invention is configured by integrating the switching diode 22 or resistor 23 into the husk 21. This additional shunt device can properly replace the shunt device disposed within the light bulb. As a result, even one of the light bulb fails, the rest of the light string may still function work without being negatively effected. Accordingly, the loss or damages can be largely reduced.

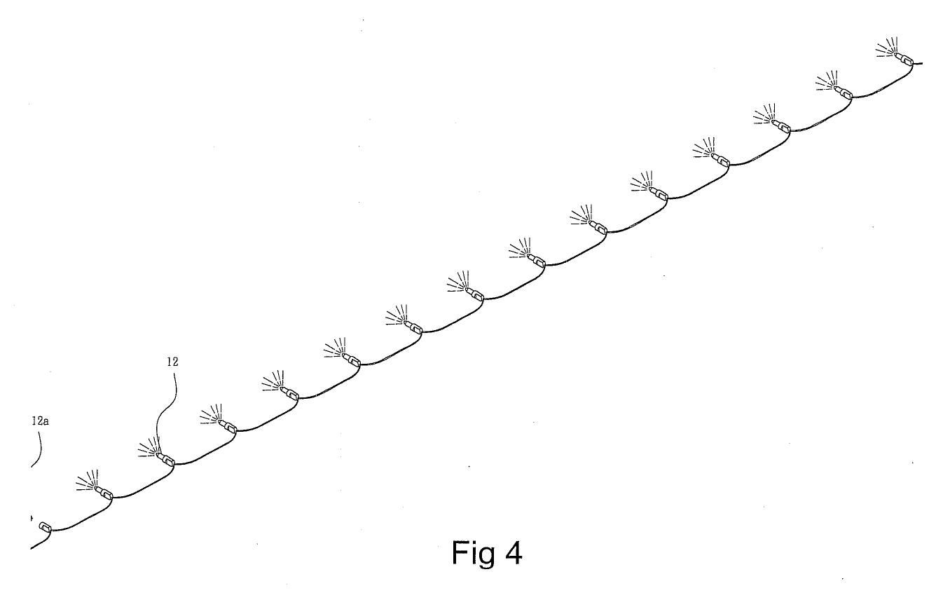

Referring to FIGS. 4, 5 and 6, illustrations and simulations of the embodiments made in accordance to the present invention. As shown in FIG. 4, the light bulb 12a is removed, and while the current is still flowing through the switching diode 22, as shown in FIG. 2, of the husk 21, or the resistor 23, as shown in FIG. 3. Accordingly, the rest of the light bulb 12 are still lit up despite the removal of the light bulb 12a, shown in FIG. 4. Accordingly, the missing or malfunction of the light bulb 12a does not negatively effect the function of the light string. However, in case of a conventional light string, it surely will fail. It is a waste, and could be blamed.

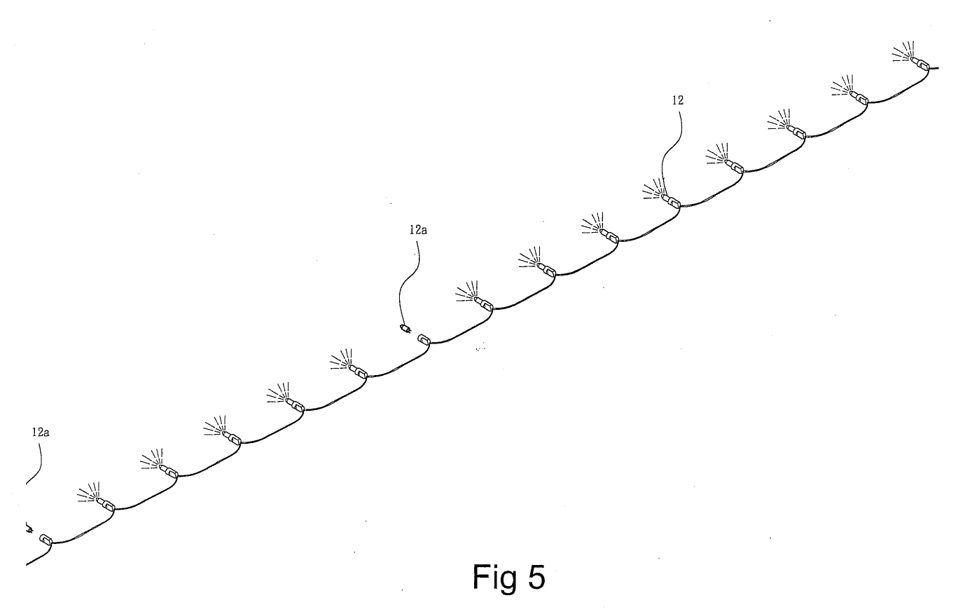

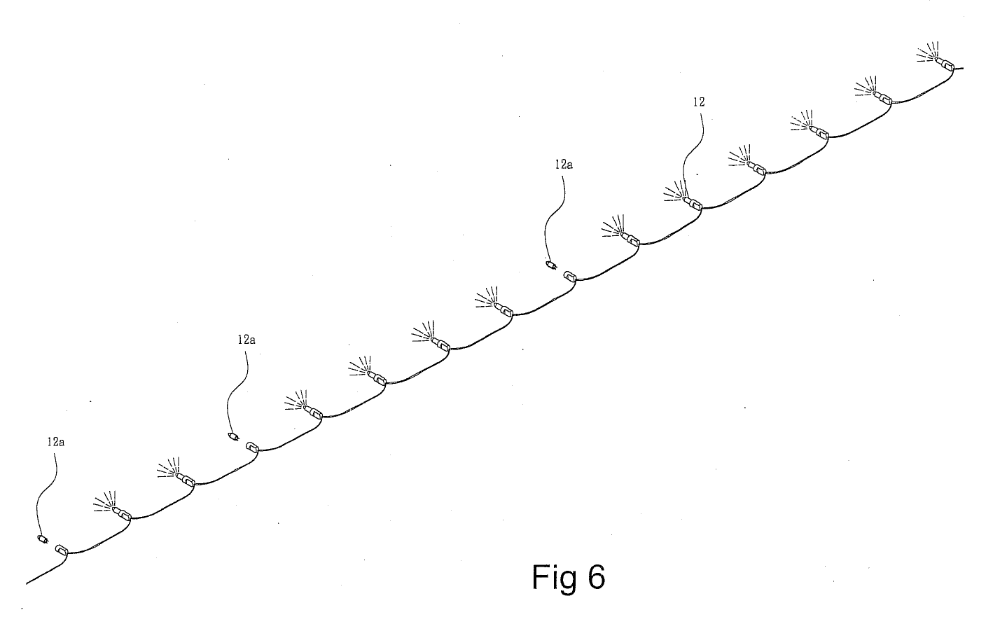

In another embodiment, there is a possibility in which two or more light bulbs are broken or malfunctioned, as shown in FIGS. 5 and 6, respectively. Even in this situation, the rest light bulbs of the light string still work functionally. Even there is no 100% guarantee on reliability on both light bulb and shunt circuitry, as long as a functional light bulb 12 is installed at any position of the light sting made in accordance the present invention, it lights up. This indeed resolves all the issues encountered by the prior art.

The present invention can be concluded with the following advantages.

Since an additional shunt device configured by the switching diode or resistor is integrated into the husk made in accordance with the present invention. As a result, either the tungsten filament or the shunt circuitry is broken, the rest of the light bulbs of the light string are still prevented from being malfunctioned. As a result, the advantages of the light string is positively elevated.

The present invention provides an unique design in which the husk is provided with a shunt device configured by a switching diode or resistor. Accordingly, no matter whether one or a plurality of light bulbs are broken or malfunctioned or even fallen apart, the rest of the light bulbs of the light string can still functionally work. It is reliable, and cost effective, and is therefore a practice invention.

What is claimed is:

1. A light string with a light bulb having additional shunt circuitry, comprising a light string comprised by a plurality of light bulb units electrically interconnected by conductive wires, each light bulb unit including a socket in which a husk along with a light bulb is electrically assembled, each light bulb arranged with a tungsten filament and a shunt circuitry, characterized in that:
the husk is provided with an additional shunt circuitry and in parallel to the shunt circuitry located within the light bulb, wherein the current flows through the additional shunt circuitry of the husk when the light bulb is fallen, broken or the tungsten filament and shunt circuitry within the light bulb is broken, such that the remaining light bulbs can still functionally work.

2. The light string as recited in claim 1, wherein the shunt circuitry located in the husk is a diode.

3. The light string as recited in claim 1, wherein the additional shunt circuitry in the husk is a resistor.
